(19) United States
(12) Patent Application Publication
(10) Pub. No.: US 2005/0198430 A1
(43) Pub. Date: Sep. 8, 2005

(54) Reproducing apparatus and method for storing history information of information reproducing apparatus

(76) Inventor: Akio Arai, Kobe-shi (JP)

Correspondence Address: HARNESS, DICKEY & PIERCE, P.L.C., P.O. BOX 8910, RESTON, VA, 20195, US

(21) Appl. No.: 11/073,570

(22) Filed: Mar. 8, 2005

(30) Foreign Application Priority Data
Mar. 8, 2004 (JP) P2004-064001

(51) Int. Cl. G06F 12/00

(52) U.S. Cl. 711/100

(57) ABSTRACT

A reproducing apparatus and a method for storing history information of an information reproducing apparatus are provided that make it possible to seek clarification of responsibility for trouble of a storage device. The reproducing apparatus includes a cover disposed so as to be changeable between a permitting state where removal of a hard disk from a casing is permitted and a restricting state where removal of the hard disk from the casing is restricted, a sensor capable of detecting that the cover is changed to the permitting state, and an external memory for updating and storing history information, the external memory storing the history information when the cover is changed to the permitting state on the basis of a detection result of the sensor.

### BACKGROUND OF THE INVENTION

1. Field of the Invention

The present invention relates to a reproducing apparatus and a method for storing history information of an information reproducing apparatus, and relates to a technique applied to equipment and the like provided with a storage device such as a hard disk drive.

2. Description of the Related Art

A storage device such as a hard disk drive is practically used in which reading and writing of data is carried out by rotating a magnetic disk a high speed with a motor and making a magnetic head approach to the disk. The hard disk drive is installed in a main unit, and removal of the hard disk drive from the main unit for the purpose of adjustment, repairs, disassembly, modification and the like by users is restricted by necessity of a special screw or the like. Moreover, a technique such that when an operation of removing the hard disk drive is detected in driving the hard disk, the drive of the hard disk is stopped and supply of electric power is stopped, is also proposed (refer to Japanese Unexamined Patent Publication JP-A 8-96493 (1996), for example).

In the technique of restricting removal of the hard disk drive from the main unit, by using a special-purpose tool, it becomes possible to remove the hard disk drive from the main unit using a special-purpose tool. In the technique proposed in JP-A 8-96493, it is impossible to prevent removal of the hard disk drive from the main unit. Even if intentional removal of the hard disk drive from the main unit by a user results in a fault of the hard disk drive itself or of the main unit, it is impossible that a manufacturer of the hard disk drive obtains the conclusive evidence that the fault is caused by the removal.

### SUMMARY OF THE INVENTION

An object of the invention is to provide a reproducing apparatus and a method for storing history information of an information reproducing apparatus that make it possible to seek clarification of responsibility for trouble of a storage device.

The invention provides a reproducing apparatus comprising:
a main unit connected to a storage device for reproducing information stored therein;
a detection portion for detecting that the storage device is removed from the main unit; and
a storage portion storing information indicating removal of the storage device from the main unit in response to the detection portion.

According to the invention, when the detection portion detects information that the storage device is removed from the main unit, the storage portion is controlled to store the information. The information about removal is secretly stored in the storage portion when the storage device is removed from the main unit despite restriction on removal of the storage device. Even when the storage device is attached to the main unit after the storage device is removed and at least one of adjustment, repairs, disassembly, modification and the like thereof is conducted, since the information about removal is stored in the storage portion, it is possible for a manufacturer to confirm that the storage device has been undesirably removed after a recall of the reproducing apparatus. This makes it possible to determine whether a trouble of the storage device has been attributed to the manufacturer or a user.

The invention provides a reproducing apparatus comprising:
a control portion for controlling the storage portion to store information, which is updated at predetermined intervals by the main unit, so as to save as information about removal from the main unit even after the removal.
   a reproducing apparatus for reproducing information stored in a storage device comprising:
a main unit;
a storage portion for storing information about removal of a storage device from the main unit; and
a control portion for controlling the storage portion to store information, which is updated at predetermined intervals by the main unit, so as to save as information about removal from the main unit even after the removal.

According to the invention, when despite a restriction on removal of the storage device, the storage device is removed from the main unit, the information about removal is secretly stored in the storage portion. Since control is carried out to store the information which is updated at predetermined intervals by the main unit, in the storage portion so as to save as the information about removal from the main unit even after the removal, the information about removal (hereinafter refer to removal information) can be reliably saved so as not to be undesirably deleted.

In the invention, it is preferable that the storage portion is disposed on the main unit.

According to the invention, the removal information can be obtained from the storage portion disposed on the main unit. Therefore, the removal information can be easily obtained from the main unit side in such a case where the storage portion has serious troubles.

In the invention, it is preferable that the storage portion is disposed on the storage device.

According to the invention, the removal information can be obtained from the storage portion disposed on the storage portion. Therefore, the removal information can be easily obtained from the storage portion side in such a case where the storage portion has serious troubles.

In the invention, it is preferable that the detection portion is disposed on the main unit and in which detection is carried out based on a restriction portion so disposed as to be changeable between a permitting state of permitting removal of a storage device from the main unit and a restricting state of restricting removal of the storage device from the main unit.

According to the invention, it is made possible for the detection portion to reliably detect whether the storage device is removed or not based on the restriction portion disposed so as to be changeable between the permitting state and the restricting state.

In the invention, it is preferable that the reproducing apparatus comprises a present position acquisition portion in which the information about removal includes position information obtained by the present position acquisition portion.

According to the invention, since the position information obtained by the present position acquisition portion is also stored in the storage portion, a manufacturer can gain the position information of the storage device at the time of being removed from the main unit. It is possible to determine more reliably whether a trouble of the storage device has been attributed to the manufacturer or a user.

In the invention, it is preferable that the reproducing apparatus comprises a timer portion for obtaining date and time information in which the information about removal includes the date and time information.

According to the invention, since the removal information includes date and time information, it is possible to determine more reliably to whom a trouble of the storage device has been attributed.

In the invention, it is preferable that the control portion prohibits information about removal of the storage device stored in the storage portion from being updated and deleted after removal of the storage device.

According to the invention, since information about removal of the storage device stored in the storage portion is prohibited from being updated and deleted after the removal of the storage device, the removal information can be reliably saved so as not to be undesirably deleted.

The invention provides a method for storing history information of an information reproducing apparatus comprising the step of:
detecting that a storage device attached to a main unit of the information reproducing apparatus for reproducing information stored in the storage device is removed;
storing information about removal of the storage device from the main unit in a storage portion of at least one of the main unit and the storage device; and
reading out information from the storage portion.

According to the invention, the removal information is stored in the storage portion at the history information storage step. Then, the removal information is read out from the storage portion, and the history of the removal of the storage portion is displayed. It is made possible for a manufacturer to gain the history immediately and take measures for troubles of the storage device.

The invention provides a reproducing apparatus for reproducing information stored in a storage device comprising:
a main body;
a storage device disposed on the main unit so as to be removable therefrom; and
a storage portion disposed on the storage device, in which a security identification code associating the main unit with the storage device is stored;
wherein the main unit verifies a security identification code of the storage device attached to the main unit, and makes it possible to read information stored in the storage device when it is verified that the security identification code corresponds to that of the main unit.

According to the invention, it is possible to read information stored in the storage device only when it is verified that the main unit and the storage device are associated by the security identification code. Conversely, it is made impossible to read information stored in the storage device when it is not verified that the main unit and the storage device are associated. Thus, data improperly stored in the storage device is prevented from being replayed, and an effect of protecting copyright is produced.

The invention provides a reproducing apparatus for reproducing information stored in a storage device comprising:
a main unit;
a hard disk unit disposed on the main unit so as to be removable therefrom; and
a storage portion disposed on the hard disk unit, in which a security identification code associating the main unit with the hard disk unit is stored;
wherein the main unit reads out and verifies the security identification code from the storage portion of the hard disk unit attached to the main unit, and when it is verified that the security identification code corresponds to that of the main unit, the main unit makes it possible to read information which is involved with copyright and stored in a hard disk of the hard disk unit.

According to the invention, it is possible to read information involved with copyright, stored in the hard disk only when it is verified that the main unit and the hard disk unit are coordinated by the security identification code. Thus, data in the hard disk is prevented from being illegally copied and altered data is prevented from being replayed, and an effect of protecting copyright is produced.

The invention provides a history information storing apparatus that is capable of storing history information about removal of a storage device from a main unit, the storage device being removable from the main unit.

According to the invention, the storage device can be removed from the main unit. When the storage device is removed from the main unit, the history information thereabout is stored.

Further, the invention provides a history information storing apparatus comprising:
restricting means disposed in a main unit, the restricting means being so disposed so as to be changeable between a permitting state of permitting removal of a storage device from the main unit and a restricting state of restricting removal of the storage device from the main unit;
detecting means capable of detecting that the restricting means is changed to the permitting state; and
storing means for updating and storing the history information when the restricting means is changed, on the basis of a detection result by the detecting means.

According to the invention, the restricting means is disposed in the main unit and so disposed as to be changeable between the permitting state and the restricting state. When the restricting means is changed from the restricting state to the permitting state, the detecting means detects the change from the restricting state to the permitting state. The storing means updates and stores the history information when the restricting means is changed, on the basis of the detection result by the detecting means.

Furthermore, in the invention, it is preferable that the history information is position information.

According to the invention, the position information when the storage device is removed from the main unit, or the position information when the restricting means is changed to the permitting state is stored. Therefore, it becomes possible to roughly specify whether the storage device is removed from the main unit or not, at a place where it is permitted to remove the storage device from the main unit. “To roughly specify” includes “to specify.”

Still further, in the invention, it is preferable that the history information includes time information.

According to the invention, the time information when the storage device is removed from the main unit, or the time information when the restricting means is changed is stored. Therefore, it becomes possible to roughly specify whether the storage device is removed from the main unit or not, within a specified time at a place where it is permitted to remove the storage device from the main unit. “To roughly specify” includes “to specify.”

Still further, in the invention, it is preferable that the apparatus further comprises controlling means for making a control so that update and erasure of the history information are forbidden, when the restricting means is changed to the permitting state.

According to the invention, the controlling means makes a control so that update and erasure of the history information are forbidden, when the restricting means is changed to the permitting state. Therefore, it is possible to securely store the history information when the restricting means is changed to the permitting state.

Still further, it is preferable that the controlling means stops an operation of specified equipment when the restricting means is changed to the permitting state.

According to the invention, the controlling means stops an operation of specified equipment when the restricting means is changed to the permitting state.

Still further, in the invention, it is preferable that predetermined identification information is stored in the controlling means and the controlling means enables the specified equipment kept in an operation stop state to operate when the identification information matches information inputted by inputting means.

According to the invention, the predetermined identification information is stored in the controlling means. The controlling means enables the specified equipment kept in an operation stop state to operate when the identification information matches information inputted by inputting means. On the contrary, the controlling means keeps the specified equipment in the operation stop state when the identification information does not match the information inputted by the inputting means.

Still further, the invention provides a history information storing method, comprising a history information storing process of storing history information about removal of a storage device from a main unit, the storage device being disposed to the main unit, and removal thereof from the main unit being restricted.

According to the invention, the main unit is provided with the storage device, and removal of the storage device from the main unit is restricted. In the history information storing process, when the storage device is removed from the main unit, the history information thereabout is stored.

According to the invention, when the storage device is removed from the main unit, the history information thereabout is stored, so that an effect as described below is produced. It becomes possible to confirm that restriction on the storage device such that removal from the main unit should be restricted is lifted. It becomes possible to clarify responsibility for trouble of the storage device after checking the history information about removal thereof.

Further, according to the invention, the storing means updates and stores the history information when the restricting means is changed, on the basis of the detection result by the detecting means, so that an effect as described below is produced. It becomes possible to confirm that removal of the storage device such that removal from the main unit should be restricted is permitted. It becomes possible to clarify responsibility for trouble of the storage device after checking the history information when the restricting means is changed.

Furthermore, according to the invention, the position information when the storage device is removed from the main unit, or the position information when the restricting means is changed to the permitting state is stored. Therefore, it becomes possible to roughly specify whether the storage device is removed from the main unit or not, at a place where it is permitted to remove the storage device from the main unit. It becomes possible to realize clarification of responsibility for trouble of the storage device after checking the position information in this way.

Still further, according to the invention, time information when the storage device is removed from the main unit, or the time information when the restricting means is changed is stored. Therefore, it becomes possible to roughly specify whether the storage device is removed from the main unit or not, within a specified time at a place where it is permitted to remove the storage device from the main unit. It becomes possible to realize clarification of responsibility for trouble of the storage device after checking the time information in this way.

According to the invention, the predetermined identification information is stored in the controlling means. The controlling means enables the specified equipment kept in an operation stop state to operate when the identification information matches information inputted by inputting means. On the contrary, the controlling means keeps the specified equipment in the operation stop state when the identification information does not match the information inputted by the inputting means. It is possible to change the equipment between an operable state and the operation stop state depending on whether the identification information matches information inputted by the inputting means or not in this way. Therefore, it becomes possible to enhance security of the history information storing apparatus.

### BRIEF DESCRIPTION OF THE DRAWINGS

Other and further objects, features, and advantages of the invention will be more explicit from the following detailed description taken with reference to the drawings wherein:

FIG. 1 is a block diagram of a control system of a history information storing apparatus according to an embodiment of the invention;

FIG. 2 is a perspective view schematically showing a relation among a main unit, a hard disk drive and a cover;

FIG. 3 is a flowchart showing an operation of the controlling means for storing history information; and

FIG. 4 is a flowchart showing an external interrupt process.

FIG. 5 is a view showing a structure of the history information.

### DETAILED DESCRIPTION OF THE PREFERED EMBODIMENTS

Now referring to the drawings, preferred embodiments of the invention are described below.

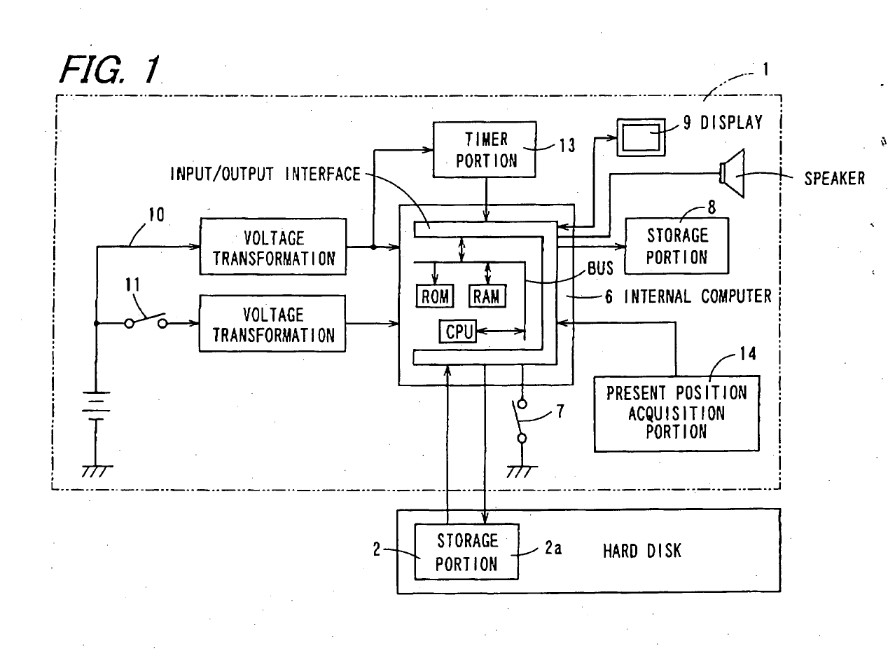

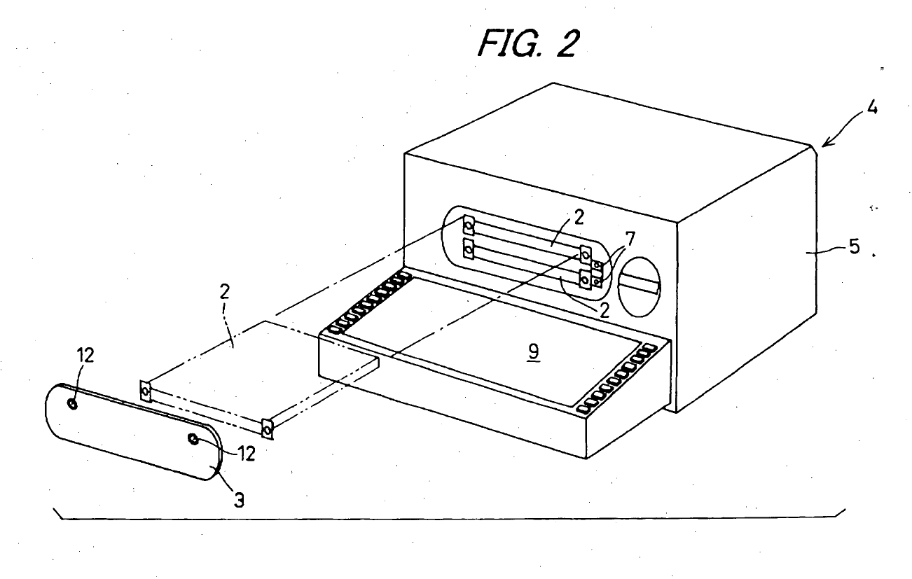

FIG. 1 is a block diagram of a control system of a history information storing apparatus 1 according to an embodiment of the invention. FIG. 2 is a perspective view schematically showing a relation among a main unit, a hard disk drive 2 and a cover 3. The present embodiment is applied to equipment such as in-vehicle equipment provided with a storage device like a hard disk drive (abbreviated as HDD). The present embodiment also includes a description of a history information storing method. The storage device is not limited to the hard disk drive necessarily. The equipment is not limited to the in-vehicle equipment necessarily. There is a case where the hard disk drive is referred to as a hard disk apparatus. The hard disk drive 2 is simply referred to as the hard disk 2 hereafter.

The in-vehicle equipment 4 serving as a reproducing apparatus for reproducing information stored in a storage device, has a casing 5 serving as the main unit, an internal computer 6, the hard disk 2, the cover 3, an open-detecting sensor 7, an external memory 8, a display 9, a normal power source 10 and an accessory power source 11. The history information storing apparatus 1 comprises the internal computer 6, the cover 3, the open-detecting sensor 7, the external memory 8, the display 9, the normal power source 10 and the accessory power source 11. In the casing 5 having a substantially rectangular shape, for example, two hard disks 2 are installed. Map data, music data and image data can be written into and read out of these hard disks 2. Removal of the respective hard disks 2 from the casing 5 is restricted. In concrete, the respective hard disks 2 are confined and protected by the cover 3 in a state where they are placed in the casing 5. The cover 3 is formed so as to be firmly attachable to the casing with a special screw 12.

The special screw 12 can be screwed with a special tool that is not defined in the Japanese Industrial Standards (abbreviated as JIS). In addition, in an instruction manual and a catalog of the in-vehicle equipment 4, a precaution like “Never remove the hard disk by yourself” is given. The cover 3 and the special screw 12 are equivalent to a restriction portion and restricting means. That is to say, the cover 3 and the special screw 12 are disposed to the casing 5 so that they can be changed between a permitting state and a restricting state. The permitting state is synonymous with a state where removal of the hard disk 2 from the casing 5 is permitted. The restricting state is synonymous with a state where removal of the hard disk 2 from the casing 5 is restricted.

In the casing 5, the internal computer 6 is housed. The internal computer 6 is provided with a microcomputer composed of a central processing unit (abbreviated as CPU), a ROM (read only memory) and a RAM (random access memory), and buses, an input-output interface and a driving circuit in the drawings. The CPU, the ROM and the RAM are electrically connected to the input-output interface via the buses.

To the input-output interface, a clock 13 as a timer portion, the open-detecting sensor 7 and the external memory 8 are electrically connected, respectively. The open-detecting sensor 7 serving as a detection portion and detecting means is a sensor that is capable of detecting that the cover 3 and the special screw 12 are changed to the permitting state, and is realized by a push switch, for example. The push switch is formed so that a switch main body thereof is included in the casing 5 and a protruding portion thereof abuts against the cover 3. The in-vehicle equipment 4 is shipped to the market in a state where the cover 3 and the special screw 12 are in the restricting state, and configured so that the push switch is kept in an off state as long as the restricting state continues. When the cover 3 and the special screw 12 are changed from the restricting state to the permitting state, the protruding portion is displaced, and the push switch is changed to an on state.

The CPU serving as a control portion and controlling means makes a control so that update and erasure of history information described later are forbidden, when the cover 3 and the special screw 12 are changed to the permitting state. Moreover, the CPU is configured so as to stop an operation of specified equipment (a car navigation system, a radio, a compact disk apparatus or the like) when the cover 3 and the special screw 12 are changed to the permitting state. Stopping the operation of the equipment is synonymous with turning off a power source of the equipment. Besides, the CPU carries on the operation stop state of the specified equipment until a security number described later is inputted. The ROM contains a program for forbidding update and erasure of the history information, stopping the operation of the equipment and carrying on the operation stop state of the specified equipment as described above. A control main part of the program is the CPU.

The external memory 8 is realized by an EEPROM (electrically erasable programmable read-only memory) for example. The EEPROM is a ROM that is electrically rewritable, and is one of storage devices such that data is not erased even if a power source is turned off. The external memory 8 is soldered and firmly attached to a board that is not shown in the drawings. Although the external memory 8 in the present embodiment is realized by the EEPROM, the external memory 8 is not limited to the EEPROM necessarily. For example, it is also possible to apply a flush memory or the like. In other words, even if the external memory 8 is realized by the flush memory, the same effect as in the present embodiment is produced. The external memory 8 is configured sc as to store the history information when the cover 3 and the special screw 12 are changed to the permitting state, on the basis of a detection result of the open-detecting sensor 7. A control main part thereof is also the CPU.

Now, the history information will be described. The history information, as shown in FIG. 5, includes at least one of position information and time information (date and time information) of the in-vehicle equipment 4, that is, of a vehicle. The position information (also referred to as map information) and the time information change with time in accordance with movement of the vehicle. The RAM temporarily stores the map information and the time information. In other words, the RAM is configured so as to update and store the map information and the time information of the in-vehicle equipment 4. The external memory 8 is configured so as to store the map information and the time information that are updated and stored in the RAM and that are the map information and the time information at the time of change to the permitting state. The CPU controls the external memory 8 to store therein the information updated at predetermined intervals so as to save as information about removal from the casing 5 even after the removal. The RAM is equivalent to a present position acquisition portion, a first storage portion and the storing means. The external memory 8 is equivalent to a second storage portion and storing means. The accessory power source 11 is disposed so as to decrease consumed electric power when the equipment is not used. The map information is temporarily stored in the RAM with use of GPS (Global Positioning System) 14 as the present position acquisition portion. The time information is temporarily stored in the RAM with use of the clock 13 as the timer portion.

Because the map information and the time information at the time of change to the permitting state are stored in the external memory 8, an effect as described below is produced. Even if switches of the normal power source 10 and the accessory power source 11 are turned off, the map information and the time information at the time of change to the permitting state are securely stored without being updated or erased. Because the external memory 8 is soldered and firmly attached to the board, removal thereof from the in-vehicle equipment 4 and the hard disk 2 is difficult. Therefore, it is possible to increase the probability that, for example, a manufacturer of the in-vehicle equipment 4 can read out the map information and the time information at the time of change to the permitting state.

Now, the security number will be described. The CPU causes the display 9 to display a security number input screen via the input-output interface and the driving circuit, when the cover 3 and the special screw 12 are changed from the restricting state to the permitting state, that is, when the push switch is turned on. In concrete, text like “Enter the security number” is displayed on the display 9.

The in-vehicle equipment 4 contains predetermined identification information, and input information, that is, the security number that matches the identification information is known by the manufacturer and a sales agency. That is to say, users of the in-vehicle equipment 4 do not recognize the security number. When either the manufacturer or the sales agency inputs the security number to be inputted with a key that is not shown in the drawings, the operation of the equipment kept in the operation stop state is permitted. In other words, the CPU is configured so as to cancel the operation stop state, which is a so-called security mode, of the equipment when confirming input of the security number to be inputted.

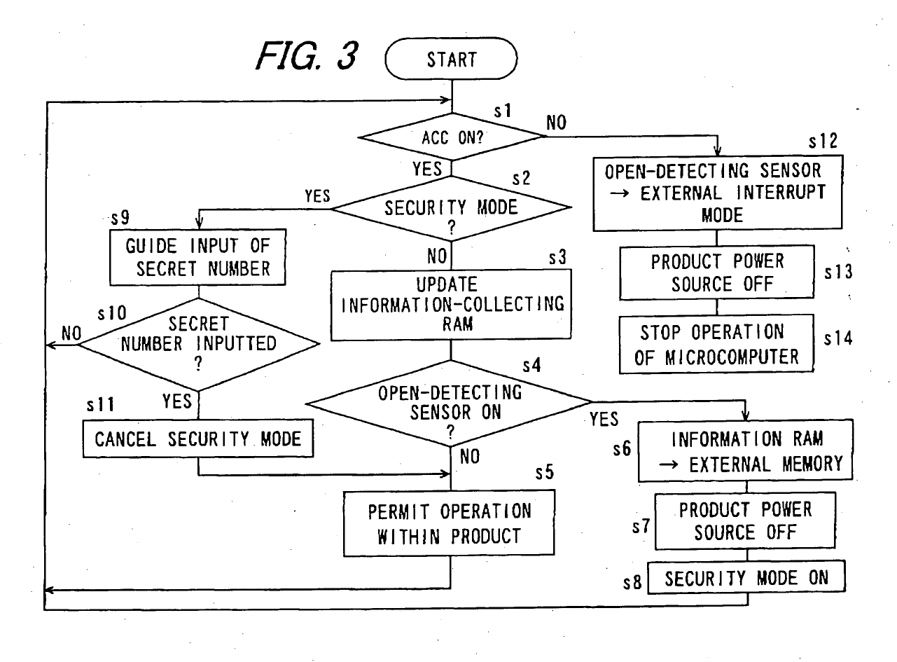

FIG. 3 is a flowchart showing an operation of the controlling means for storing the history information. On condition that the in-vehicle equipment 4 is placed in the vehicle and placed in an initial state, the present flow starts. After the present flow starts, at step s1, the CPU determines whether the accessory power source 11 (abbreviated as ACC) is on or not. When it is determined at step s1 that the ACC is on, the process goes to step s2. At step s2, the CPU determines whether the security mode is set or not. When the CPU determines that the security mode is not set, the process goes to step s3, where the CPU causes the RAM to temporarily store the map information and the time information. The RAM updates and stores the map information and the time information.

Next, the process goes to step 4, where the CPU determines whether the open-detecting sensor 7 is brought to an on state or not. When it is determined here that the open-detecting sensor 7 is not in the on state, that is, the restricting state is set, the process goes to step s5. At step s5, the CPU permits the operation of the specified equipment. After that, the process goes back to step s1. When the CPU determines at step s4 that the open-detecting sensor 7 is brought to the on state, the process goes to step s6. At step s6, the CPU transfers the map information and the time information that are updated and stored in the RAM, to the external memory 8. Next, the process goes to step s7, where the CPU brings the specified equipment to the operation stop state, and the CPU changes the equipment to the security mode at step s8. After that, the process goes back to step s1. The step s4 is equivalent to “a step of detecting that the storage device is removed”. The step s5 is equivalent to “a history information storage step”.

When the CPU determines at step s2 that the security mode is set, the process goes to step s9. At step s9, the CPU causes the display 9 to display the security number input screen. Next, the process goes to step s10, where the CPU determines whether the security number to be inputted is inputted or not. When the CPU determines at step s10 that the security number is not inputted, the process goes back to step s1. When the CPU determines that the security number is inputted, the process goes to step s11, where the CPU cancels the security mode. After that, the process goes to step s5.

When it is determined at step s1 that the ACC is not on, the process goes to step s12. At step S12, the CPU changes the open-detecting sensor 7 to an external interrupt mode that will be described later. Next, the process goes to step s13, where the CPU brings the specified equipment to the operation stop state. That is to say, the CPU turns off the power source of the specified equipment. After that, the process goes to step s14, where the CPU stops an operation of the microcomputer.

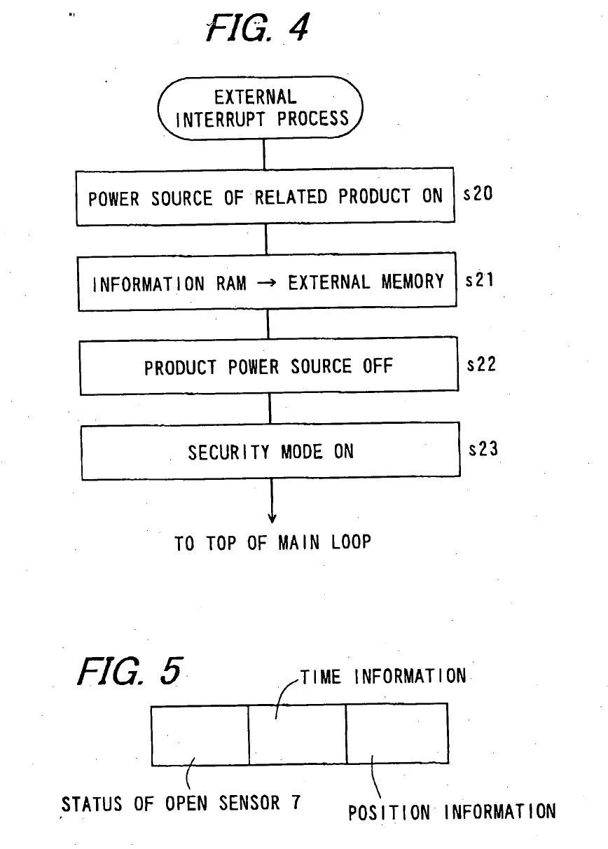

FIG. 4 is a flowchart showing an external interrupt process. When there is a change of the open-detecting sensor 7 after the process goes to the external interrupt mode at step s12, the microcomputer restarts. That is to say, on condition that the open-detecting sensor 7 is turned on, the external interrupt process is started. Next, the process goes to step s20, where the CPU enables the specified equipment to operate, that is, turns on the power source of the equipment. Next, the process goes to step s21, where the CPU transfers the map information and the time information that are updated and stored in the RAM, to the external memory 8. After that, the process goes to step s22, where the CPU turns off the power source of the specified equipment. Next, the process goes to step s23, where the CPU changes the equipment to the security mode. After than, the process goes back to step s1 of a main routine shown in FIG. 3.

According to the history information storing apparatus 1 described above, the RAM updates and stores the map information and the time information, and the external memory 8 stores the map information and the time information when the cover 3 and the special screw 12 are changed to the permitting state on the basis of the detection result of the open-detecting sensor 7, so that an effect as described below is produced. It becomes possible to confirm a fact that removal of the hard disk 2 whose removal from the casing 5 is restricted is permitted from the map information and the time information that are stored.

That is to say, in the in-vehicle equipment 4 recalled by the manufacturer, it is possible to check the map information and the time information when the cover 3 and the special screw 12 are changed to the permitting state, and thereafter, roughly specify a place and time that removal of the hard disk 2 is permitted. For example, it is possible to specify that removal of the hard disk 2 is undesirably permitted at a place where removal of the hard disk 2 is not authorized by the manufacturer. For example, it is possible to specify that removal of the hard disk 2 is undesirably permitted after business hours of the sales agency authorized by the manufacturer to remove the hard disk 2. Therefore, it becomes possible to clarify whether responsibility for trouble of the hard disk 2 is of the user or of the manufacturer.

The RAM serving as the first storing means updates and stores the map information and the time information. The external memory 8 serving as the second storing means stores the map information and the time information when the cover 3 and the special screw 12 are changed to the permitting state, on the basis of the detection result of the open-detecting sensor 7. By thus separating the RAM and the external memory 8 by function, it is possible to securely prevent the map information and the time information from being erased undesirably. Moreover, the CPU controls so as to forbid update and erasure of the map information and the time information, when the cover 3 and the special screw 12 are changed to the permitting state. In addition, because the CPU transfers the map information and the time information that are updated and stored in the RAM, to the external memory 8, it becomes possible to securely store the map information and the time information that are desired.

The CPU can stop the operation of the specified equipment when the cover 3 and the special screw 12 are changed to the permitting state. In addition, when either the manufacturer or the sales agency inputs the security number to be inputted by the key that is not shown in the drawings, the operation of the equipment kept in the operation stop state is thereby permitted. Conversely, because the users do not recognize the security number, the users cannot recover the equipment so as to be operable by themselves when the equipment is once bought to the operation stop state. Therefore, it becomes possible to enhance security of the in-vehicle equipment 4 and the history information storing apparatus 1.

As another embodiment of the invention, it is possible to provide the internal computer with another storage device such that data is not erased even if a power source is turned off, and configure so as to store at least one of the map information and the time information at the time of change to the permitting state into the other storage device. According to the configuration of the internal computer like this, it is possible to omit the external memory, and it is possible to simplify a structure of the equipment. It is also possible to add a step of reading out the information about removal from the RAM or external memory 8, and displaying a history of removal of the hard disk 2 as the storage device. In this case, it is made possible to gain the history immediately and take measures for troubles of the hard disk. It is also possible to apply a switch or a sensor other than the push switch, as the detecting means. It is also possible to configure such that a function as the detecting means is applied to the screw for firmly attaching the cover 3 to the casing 5. Although the special screw 12 is applied in the present embodiment, it is possible to apply a screw defined in the JIS, conversely. Moreover, it is also possible to configure such that the cover is firmly attached to the casing by the use of alternative means to the screw.

The restricting means is not limited to the cover and the special screw. A member that should be necessarily displaced or removed in order to remove the hard disk from the casing for the purpose of adjustment, repairs, disassembly, modification and the like thereof is sufficient as the restricting means. It is also possible to configure so that only the manufacturer knows the security number. The storage portion 2a for storing the removal information of the storage device may be disposed on the storage device 2. The storage device 2 including the storage portion 2a is equivalent to “hard disk unit” (refer to FIG. 2). In a case where the main unit 5 of the in-vehicle equipment has serious troubles, the removal information can be easily obtained from the storage device 2 side.

In a case where the storing portion 2a is disposed on the storage device 2, such a configuration may be also realized that a security identification code which associates the storage device 2 with the main unit 5 of the in-vehicle equipment 4 is stored in the storing portion 2a. The main unit 5 of the in-vehicle equipment 5 verifies the security identification code of the storage device 2 attached thereto, and when the security identification code corresponds to that of the main unit 5, it is possible to read information stored in the storing portion 2.

According to such a configuration, it is possible to read information (for example, copyright information such as music data) stored in the storage device 2 only when it is confirmed that the main unit 5 and the storage device 2 are associated with each other by the security identification code. Conversely, it is made impossible to read the information stored in the storage device 2 when it is not confirmed that the main unit 5 and the storage device 2 are associated with each other. Thus, data illegally stored in the storage device 2 is prevented from being reproduced, and an effect of protecting copyright is produced.

The hard disk unit 2 including the storage portion 2a may be so configured that the optional main unit 5 reads out and verifies the security identification code from the storage portion 2a of the hard disk unit 2 attached to the main unit 5, and makes it possible to read the information involved with copyright, stored in the hard disk of the hard disk unit 2 when it is confirmed that the security identification code corresponds to that of the main unit 5. According to the configuration, it is possible to read information involved with copyright, stored in the hard disk only when it is confirmed that the main unit 5 and the hard disk unit 2 are associated with each other by the security identification code. Thus, data in the hard disk is prevented from being illegally copied and altered data is prevented from being reproduced, and an effect of protecting copyright is produced.

Incidentally, the hard disk is designed to store copyright information such as music data. The hard disk is equipped with the main unit 5, and designed not to be removed easily by a special screw. For example, it is assumed that the hard disk is not usually operated by a main unit belonging to other users. However, there arises such problems that copyright information is leaked to third parties other than a true user when the hard disk forcibly removed from the main unit, for example, the user, and the hard disk is transferred to another main unit to reproduce.

Consequently, as described above, it is configured that access is permitted only when security identification codes of the main unit 5 and the hard disk unit 2 matches by verifying each other with use of the security identification codes for making it possible to access only between the main unit 5 and the hard disk unit 2. In other words, it is configured that access cannot be attained when the security identification codes are different from each other. That is, the main unit 5 and the hard disk unit 2 are configured to be one-on-one connected. There produced is an effect of preventing information involved with copyright, individual information about users, private information, and the like stored in the hard disk unit 2 removed from the main unit 5 from being leaked.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

1. A reproducing apparatus comprising:
a main unit connected to a storage device for reproducing information stored therein;
a detection portion for detecting that the storage device is removed from the main unit; and
a storage portion storing information indicating removal of the storage device from the main unit in response to the detection portion.

2. A reproducing apparatus according to claim 1 further comprising:
a control portion for controlling the storage portion to store information, which is updated at predetermined intervals by the main unit, so as to save as information about removal from the main unit even after the removal.

3. The reproducing apparatus according to claim 1, wherein the storage portion is disposed on the main unit.

4. The reproducing apparatus according to claim 1, wherein the storage portion is disposed on the storage device.

5. The reproducing apparatus according to claim 1, wherein the detection portion is disposed on the main unit and in which detection is carried out based on a restriction portion so disposed as to be changeable between a permitting state of permitting removal of a storage device from the main unit and a restricting state of restricting removal of the storage device from the main unit.

6. The reproducing apparatus according to claim 1, further comprising a present position acquisition portion in which the information about removal includes position information obtained by the present position acquisition portion.

7. The reproducing apparatus according to claim 1, further comprising a timer portion for obtaining date and time information in which the information about removal includes the date and time information.

8. The reproducing apparatus according to claim 1, wherein the control portion prohibits information about removal of the storage device stored in the storage portion from being updated and deleted after removal of the storage device.

9. A method for storing history information of an information reproducing apparatus comprising the step of:
detecting that a storage device attached to a main unit of the information reproducing apparatus for reproducing information stored in the storage device is removed;
storing information about removal of the storage device from the main unit in a storage portion of at least one of the main unit and the storage device; and
reading out information from the storage portion.

10. A reproducing apparatus for reproducing information stored in a storage device comprising:
a main body;
a storage device disposed on the main unit so as to be removable therefrom; and
a storage portion disposed on the storage device, in which a security identification code associating the main unit with the storage device is stored;
wherein the main unit verifies a security identification code of the storage device attached to the main unit, and makes it possible to read information stored in the storage device when it is verified that the security identification code corresponds to that of the main unit.

11. A reproducing apparatus for reproducing information stored in a storage device comprising:
a main unit;
a hard disk unit disposed on the main unit so as to be removable therefrom; and
a storage portion disposed on the hard disk unit, in which a security identification code associating the main unit with the hard disk unit is stored;
wherein the main unit reads out and verifies the security identification code from the storage portion of the hard disk unit attached to the main unit, and when it is verified that the security identification code corresponds to that of the main unit, the main unit makes it possible to read information which is involved with copyright and stored in a hard disk of the hard disk unit.

12. A history information storing apparatus that is capable of storing history information about removal of a storage device from a main unit, the storage device being removable from the main unit.

13. A history information storing apparatus comprising:
restricting means disposed in a main unit, the restricting means being so disposed so as to be changeable between a permitting state of permitting removal of a storage device from the main unit and a restricting state of restricting removal of the storage device from the main unit;
detecting means capable of detecting that the restricting means is changed to the permitting state; and
storing means for updating and storing the history information when the restricting means is changed, on the basis of a detection result by the detecting means.

14. The history information storing apparatus according to claim 12, wherein the history information includes position information or time information.

15. The history information storing apparatus according to claim 13, wherein the history information includes position information or time information.

16. The history information storing apparatus according to claim 13, further comprises controlling means for making a control so that update and erasure of the history information are forbidden, when the restricting means is changed to the permitting state.

17. The history information storing apparatus according to claim 13, wherein the controlling means stops an operation of specified equipment when the restricting means is changed to the permitting state.

18. The history information storing apparatus according to claim 13, wherein predetermined identification information is stored in the controlling means and the controlling means enables the specified equipment kept in an operation stop state to operate when the identification information matches information inputted by inputting means.

19. A history information storing method, comprising a history information storing process of storing history information about removal of a storage device from a main unit, the storage device being disposed to the main unit, and removal thereof from the main unit being restricted.
